(19) United States
(12) Patent Application Publication
(10) Pub. No.: US 2006/0218833 A1
(43) Pub. Date: Oct. 5, 2006

(54) Display system

(76) Inventor: Herman Spira, Spring Valley, NY (US)

Correspondence Address: ISRAEL NISSENBAUM, 1038-56TH ST, BROOKLYN, NY, 11219, US

(21) Appl. No.: 11/092,799

(22) Filed: Mar. 29, 2005

(51) Int. Cl. G09F 21/04

(52) U.S. Cl. 40/590

(57) ABSTRACT

A display system for particular use on vehicle sides. The system includes an aluminum frame affixed to the vehicle, with non-elastic and elastic element interposed between an indicia display sheet or banner of vinyl canvas and the frame. The banner is kept in drum tight condition at all times. The system also includes installing tools and readily removable elements for facilitated quick change of display.

### FIELD OF THE INVENTION

This invention relates to message display systems, both stationary displays and moving displays on vehicles such as billboards and banners and in particular the present invention relates to easily changeable banner display systems for truck side panels.

### BACKGROUND OF THE INVENTION

The space on vehicle exteriors provides an ideal surface for the display of indicia on a sheet such as of the form of billboards and banners with advertisements, sponsorship, political statements and messages of all types. Many trucks, buses, and other vehicles are adorned with such displays. These displays, are most often advertisement messages, and are usually simply decals pasted on the sides of trucks. This makes their removal and change of display difficult. Pasting one display on top of another is both messy and unstable since a display surface itself is not a good supporting base and base advertisement removal is tedious and time consuming. Alternatively, ridged cardboard posters are fitted to slide into a U-channel track affixed to the side of truck panels. While this makes placement, removal and changes easier it is at the cost of deteriorated appearance, particularly wrinkling and bulging resulting from winds generated by vehicle movement. Additionally, a controllable maximum size of about three feet in height limits the optimal display appearance. Painted on or decal messages are generally intended to be permanent, of a type such as indicia of vehicle ownership.

To obviate display degradation, some cardboard or canvas truck displays have been removably fastened along a side U-channel panel surface by means of spring retaining elements. However, the springs used with such displays tend to fatigue under constant movement vibration, with resultant loss of tension and, inevitably, the degradation of appearance.

### SUMMARY OF THE INVENTION

It is accordingly an object of the present invention to provide a system for both stationary and moveable sheet displays such as billboards and banners and particularly a vehicle display system which is and remains stable and aesthetic, i.e., drum tight, even under motion and vibration stress.

It is a further object to provide a display system which allows for facilitated changes of display indicia sheets while being adaptable for various configurations and surfaces upon which a display is seated.

It is yet another object of the present invention to provide an aesthetic frame element for framing a banner display.

These and other objects, features and advantages of the present invention will become more evident from the following discussion and drawings in which:

### SHORT DESCRIPTION OF THE DRAWINGS

FIG. 1 depicts a side of a truck having the display system of the present invention affixed thereon;

FIGS. 2a and 2b are isometric end views of a portion of the frame section of FIG. 1, shown in the cover-open position, without and with the connector elements positioned thereon (and attached to a bead edge portion of the display indicia), respectively;

FIG. 2c is an end view of a mitred frame section showing a bull-nose hinge;

FIG. 3 is a view of the frame section of FIG. 2b in the cover closed position;

FIG. 4 is a view of a second embodiment of the frame section of FIG. 2a, adapted for stationary displays, without a cover element;

FIG. 5 is an isometric view of a slotted non-elastic connector element which is connected to and positioned between the indicia display and an elastic or bungee band element(the term “bungee”, as used herein, is an elastic which snaps back to an original shape and dimension, when stress is relieved);

FIG. 6 is an isometric view of the elastic bungee band element;

FIG. 7 is an isometric view of the slotted non-elastic connector element positioned between the elastic bungee band element and the frame section;

FIG. 8 is an isometric view of the assembled elastic connecter member;

FIG. 9 is a second embodiment of the slotted non-elastic connector element between the indicia and an elastic bungee cord element;

FIG. 10 is a view of the elastic or bungee cord element;

FIG. 11 is an isometric view of the non-elastic connector element positioned between the bungee cord element and the frame section;

FIG. 11a is an isometric view of the assembled elastic connector member with the elements of FIGS. 9-11;

FIG. 12 is an isometric view of a clip used to retain the frame cover of FIG. 4 in a frame closed position;

FIG. 13a is a view of a “quarter turn” fastener used to retain the cover element of FIG. 3 in place, together with an elongated tensioning spring showing the interlocking elements;

FIG. 13b is a view of the spring of FIG. 13a riveted to the rear of the frame;

FIG. 13c is a view of the quarter turn fastener positioned for locking placement and engagement with the spring of FIG. 13b;

FIG. 14a is an isometric view of a ratcheting spreading tool used to spread the elastic bungee band (or cord), to facilitate placement of the connecter on the frame;

FIG. 14b is a view of the spreading tool shown in FIG. 14a as deployed in spreading the elastic bungee band;

FIG. 15 is a view of a connector element being placed and positioned in a channel of the frame member;

FIG. 16 is an view of a safety band and connector elements used to back up the bungee band connection; and

FIG. 17 is a view of the elastic band member being positioned on a banner display.

### SUMMARY OF THE INVENTION

Generally the present invention comprises a system for tensioned display of indicia such as artwork and advertising, on a stationary base including billboards and on a moving vehicle base and in particular the side or rear panels of a truck.

The system comprises a frame element which is removably or preferably permanently affixed to the stationary base or moving vehicle base by a stud, bolt or other suitable fastener. The fasteners are preferably affixed to the supporting studs of the truck walls which support the sheet metal siding of the truck walls.

As affixed to the supporting base, the frame element comprises means for releasable connection with tensioned elastic connection means. The tensioned elastic connection means provides a tensioned interface between the indicia and the frame element, thereby maintaining the indicia in an aesthetic fully stretched condition.

In a preferred embodiment, the elastic connection means comprises an elastic element of a strength sufficient to resist continued elongation and loss of tension. In a further preferred embodiment the elastic connection means comprises a first non-elastic member having means for removable engagement with the indicia and one side of the elastic element and a second non-elastic member having means for removable engagement with the frame element and another side of the elastic element whereby an overall elastic engagement is effected between the indicia and the frame element. Removable engagement between the elastic element and the non-elastic members is preferred though not required. The elastic element contracts and expands to maintain the indicia in a fully stretched position at all times even when the vehicle is in normal high speed motion.

A stationary base for the indicia generally requires only two opposing framing elements (top and bottom or right and left) whereas a moving vehicle base requires framing elements on the two sets of opposing sides, i.e. all four sides, as necessitated by moving wind currents.

### DETAILED DESCRIPTION OF THE INVENTION

In a preferred embodiment of the present invention and particularly for use with moving vehicles such as trucks, the frame element is comprised of heavy duty profiled aluminum with mitered ends. Alternatively, preformed mitered ends and straight lengths may be used with either or both, cut to requisite size, or straight lengths are both mitered and straight cut as needed. The aluminum is light weight and resists corrosion and the mitered ends (when butted) provide an aesthetic frame appearance. The elastic connection means preferably comprises three elements:

1) a first non-elastic element having means for engagement with the indicia display (such as with a bead formed at the edge of the indicia by enclosing a plastic rod within a plastic or fabric material which is bonded to the edge of the indicia). The engagement means of the non-elastic element preferably comprises two short (about 3-4″ long) slotted tubes which are formed or bonded together, with the slots being positioned along a single vertical plane (with the tubes vertically aligned). One or either of the slotted tubes permits lateral insertion of the display indicia bead therein while the indicia (usually of vinyl canvas) slides through the slot of that tube. The indicia bead itself is discontinuous, with sufficient space for insertion of one or more slotted tubes thereon and sliding movement of the tube to a requisite position on the bead;

2) a second non-elastic element, comprising means adapted for attachment to the frame element, preferably comprising a rod member adapted to fit within a co-fitting elongated channel enclosure section of the frame member (the channel enclosure section has at least one “raceway” or open area to accommodate insertion of the rod member and movement thereafter to a requisite position). The rod member is integrated with a slotted tube with the slot being in the same plane as the rod; and

3) an elastic band element comprised of a stiff rubber or elastic, integrated with two transverse solid cylinder sections adapted to fit within the slotted tubes of each of the first and second non-elastic elements, with the band fitting within the slots of the tubes of the first and second non-elastic elements. The cylinder sections preferably extend beyond the adjacent edges of the band for engagement with a stretching tool.

In another embodiment of the present invention, the elastic element is a cord instead of a band and the slots of the connection elements are configured to provide a wedged connection with the cord to effect a similar elastic connection.

The elastic band element (as well as the cord) is preferably an EPDM rubber silicon material having a taut resilience and high strength. The non-elastic connector elements are preferably formed of molded polycarbonate.

For ease of use and handling, the tubes and cylinders of the embodiment of the elastic band, and the first non-elastic element are of the same co-fitting dimensions whereby they can be interchangeably or reversibly positioned.

The co-fitting elongated channel enclosure section of the frame member into which the rod of the second non-elastic element is positioned is provided with an open raceway section of a dimension sufficient to permit insertion of the rod member of the second non-elastic element therein and sliding movement within the channel enclosure section to a retaining section of the channel.

Numerous elastic connection means assemblies are emplaced, generally at intervals of between a foot to a foot and a half (i.e., sufficiently close to prevent wrinkling of the indicia).

In operation of the display system, the aluminum frame segments are cut to size and miter cut (or precut sections are used) and the segments are adapted to form a rectangular or square frame. The frame member segments are then fastened to a base (e.g., truck side panel) such as with rivets or screws (preferably with tensioned washers or springs to avoid loosening with movement) to provide the frame configuration. Advertising or other display indicia is printed on vinyl canvas and a bead is provided on the edges of the display by enclosure of a hard plastic rod within a fabric or plastic material which is enclosingly bonded to the vinyl canvas material.

The elastic connection means assembly is attached to the indicia display bead at the requisite intervals. A slotted tube of the first non-elastic element is guided onto the indicia bead (sized to fit within the tube and slotted to closely accommodate the vinyl canvas). The elastic connection means assemblies are then simply inserted into the respective raceways and holding channels of adjacent frame elements (top and one side or bottom and one side of the frame). The display is then stretched to the opposite sides with placement of the respective elastic connection means assemblies into the holding channels of the frame members. The stretching is readily effected by utilizing the slotted tube of the first non-elastic elements. A cord or rope is looped through the open tube (prior to placement of the elastic element therein and the display, engaged with the non-elastic element tube, is readily pulled thereby.

To facilitate placement of the elastic member in the frame, the elastic band is stretched with a ratcheted expansion tool comprising spaced tooth elements which engage the facing extension portions of the solid cylinders of the elastic band to move the cylinders apart and stretch the band. While the band is stretched, the rod member of the second non-elastic member is fed into the adjacent raceway of the frame member and moved into a holding position. The ratchet is released and the band snaps to a tensioned holding state.

In a second embodiment of the present invention a bungee cord is used in place of the bungee band. In such embodiment the slots in the respective tubes are partial and the cord is fed into the respective tubes and forced into a wedged engagement with the ends of the bungee cord. This results in the requisite tensioned holding of the display indicia.

For stationary displays such as billboards only top and bottom or right and left framing elements may be necessary and the framing member need not have a hinged cover. For aesthetic purposes, moldings may be sufficient to cover screw holes and the like. Moving displays are subject to winds and require framing member holding at all four sides. In this latter embodiment it is highly preferred that the framing member also comprise frame cover elements hingedly attached to the frame elements and which are held in position by end clips or alternatively by quickly deployed quarter turn fasteners, e.g., of a bayonet type with pin and groove. Both the clip and quarter turn fasteners are preferably spring loaded (the latter with spring washer elements) to avoid loosening with vibration motion. In a preferred embodiment the spring load element is integrated with the pin engagement element.

In order to prevent interference of the frame cover elements with the base frame elements, upon hinging closure at the mitered ends, the hinge connection element of the frame cover elements are provided with bull-nose cuts.

As a safety measure vinyl canvas bands of a length greater than that of the elastic bands is provided with connection elements similar to that of the elastic bands. Should the elastic bands snap or be disengaged these vinyl canvas bands will keep the display in place albeit loosely.

### DETAILED DESCRIPTION OF THE DRAWINGS AND THE PREFERRED EMBODIMENTS

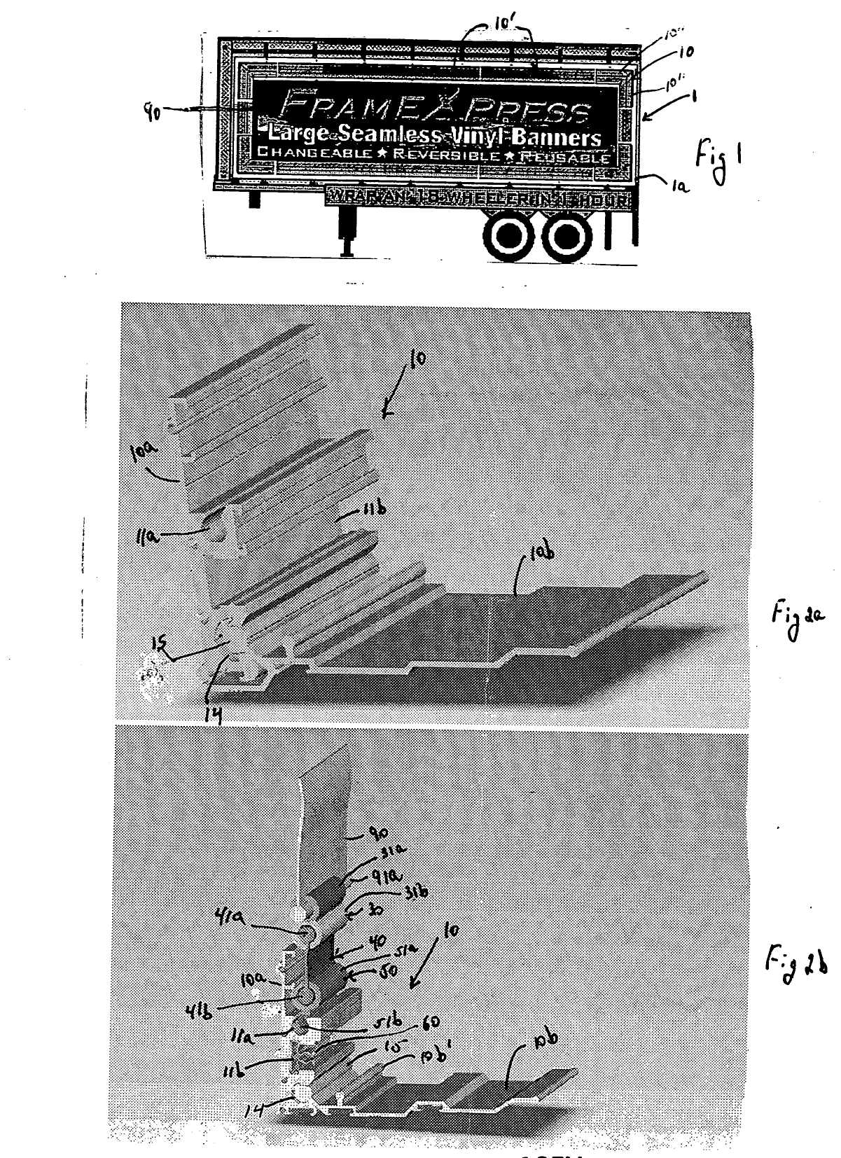

With specific reference to the drawings, in FIG. 1, a truck cargo body 1 having a side surface la, is provided with an aluminum frame 10 which is cut and sized to fit the side panel surface 1a, with straight sections 10′ and mitered sections 10″. A printed vinyl canvas advertising display 90 (sized to the inner dimensions of the frame) is stretched across the frame 10 and is resiliently held thereby.

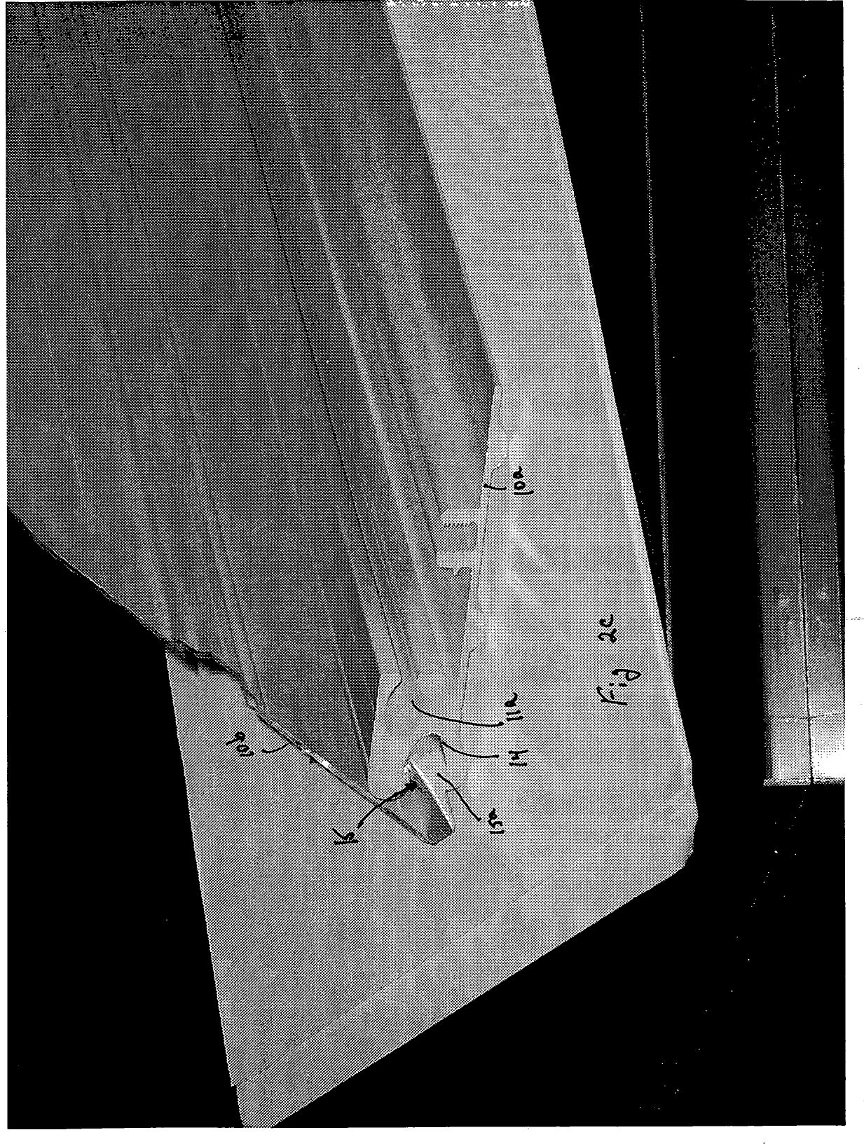

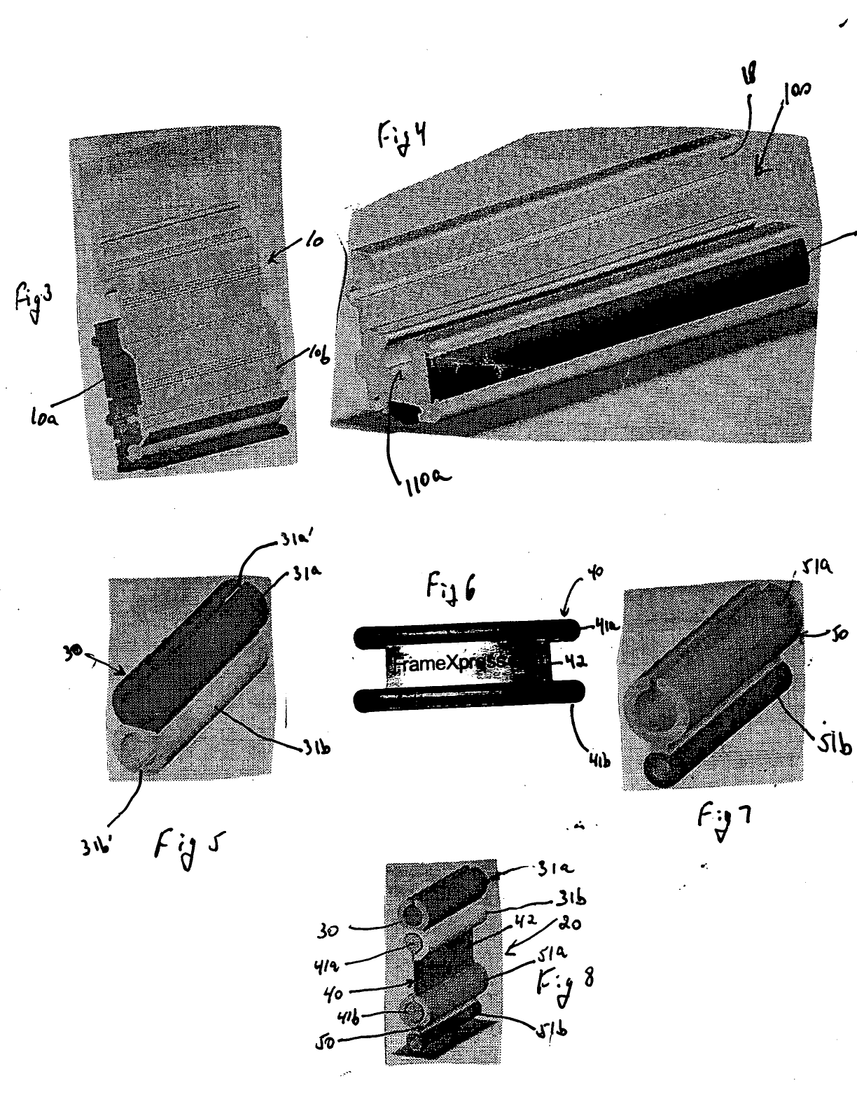

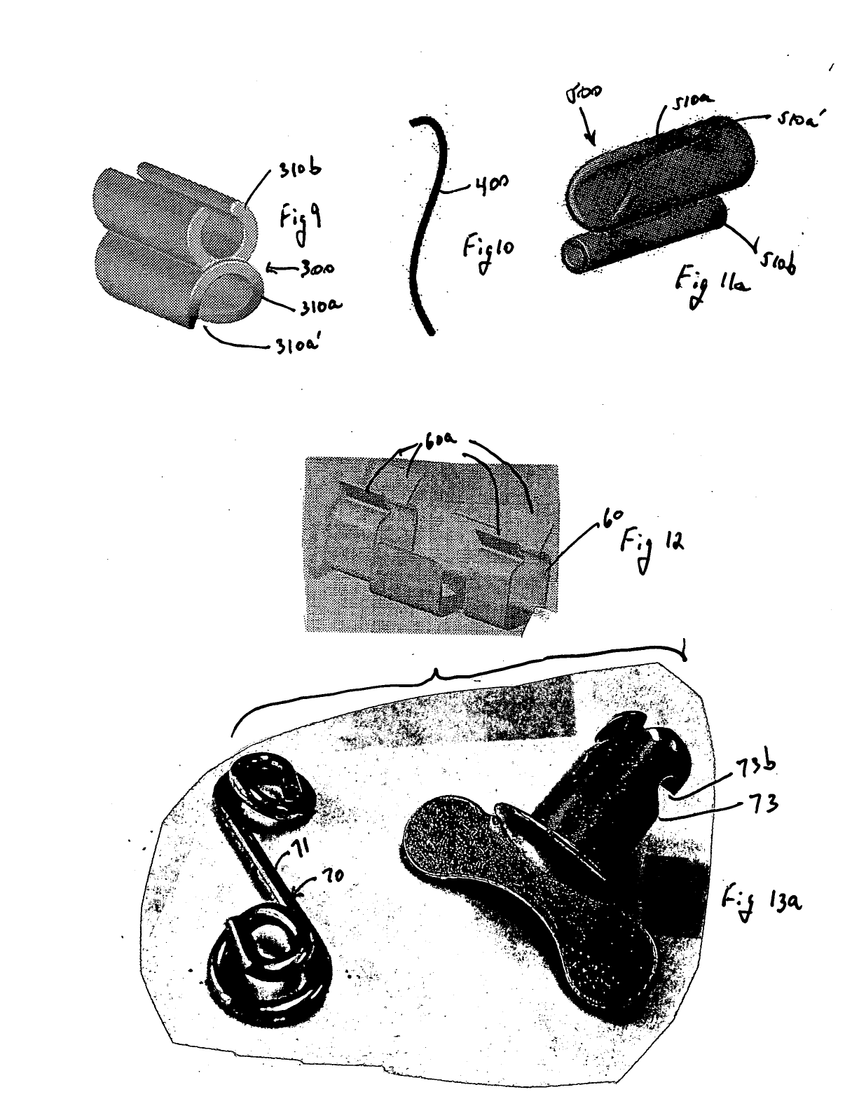

As shown in FIGS. 2a, 2b and 3, the frame 10 comprises a base supporting section 10a and a cover section 10b. Hinge element 15, at an end of cover 10b, is laterally inserted into channel 14 of base support 10a. Cover section 10b is able to swivel between the closed position shown in FIG. 3 and the open position of FIGS. 2a and 2b. At the corners or mitred section of frame 10, as shown in FIG. 2c , hinge element 15 is provided with a bull nose configuration 15a whereby hinge elements of adjacent mitred frame sections are able to interfit without hindering full hinging action

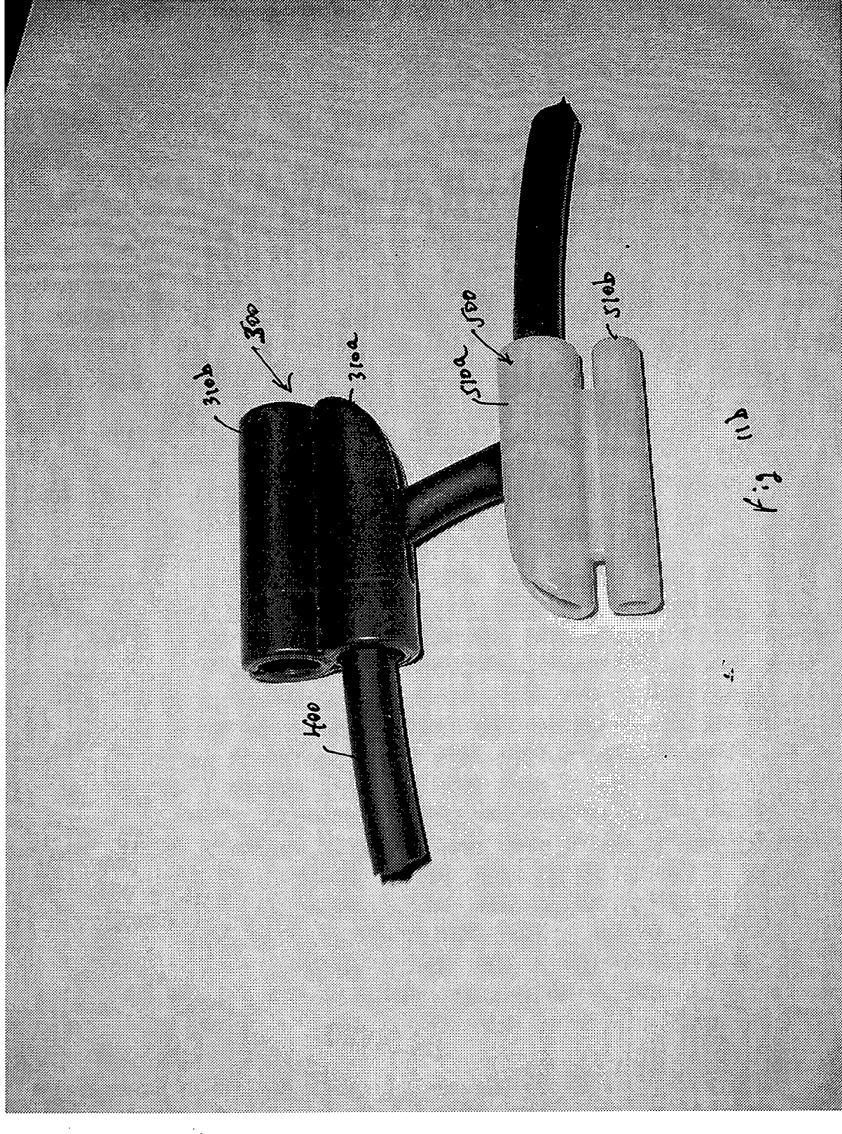

Frame 10a is preferably fastened to the truck side with tensioned fasteners such as integrated spring loaded fasteners (not shown) to minimize vibratory loosening during truck motion. Frame base 10a comprises a connector holding channel 11a and a clip containing channel 11b. Elastic connector member 20, shown in FIG. 8, is comprised of three parts, a first connector element 30, a second connector element 50 and an elastic band element 40 positioned therebetween and being removably attached to both of the connector elements.

The edge of vinyl canvas display 90 is sealingly formed with beads 91a-d (with bead 91a shown in FIG. 2b). The first connector element 30 comprises two attached slotted tubes 31a and 31b each of which is sized to engage with beads 91a-d while permitting canvas 90 to pass though slots 31a′ or 31b′. As shown in FIG. 17. Beads 91a-d are interrupted with openings 92a-d (92a shown) to permit engaged insertion of element 30 onto the bead 91a.

The elastic band element 40 has a band 42 with integral cylinders 41a and 41b, with one of the cylinders fitting within the tube 31a or 31b of the first connecting element 30 (whichever is left open after attachment of the first connector element with the beads 91a-d). As shown in the Figures, tube 31a engages bead 91a and tube 31b engages elastic band element cylinder 41a.

The second connecting member 50 is comprised of tube 51a and rod 51b. Tube 51a is adapted for engagement with the remaining cylinder of the elastic band member. As shown, tube 51a engages elastic band member cylinder 41b. Rod 41b is fitted into connector holding channel 11a to complete the elastic connection between the vinyl canvas indicia 90 and the frame 10, to effect the tensioned holding. FIG. 8 depicts the completed elastic connecting member 20 with its three components and FIGS. 2b and 17 show the connecting member as emplaced on the frame, into connection with the indicia 90. For optimum holding, elastic connecting members 20 are utilized at positions of the frame of every one to one and half feet of linear length of the frame.

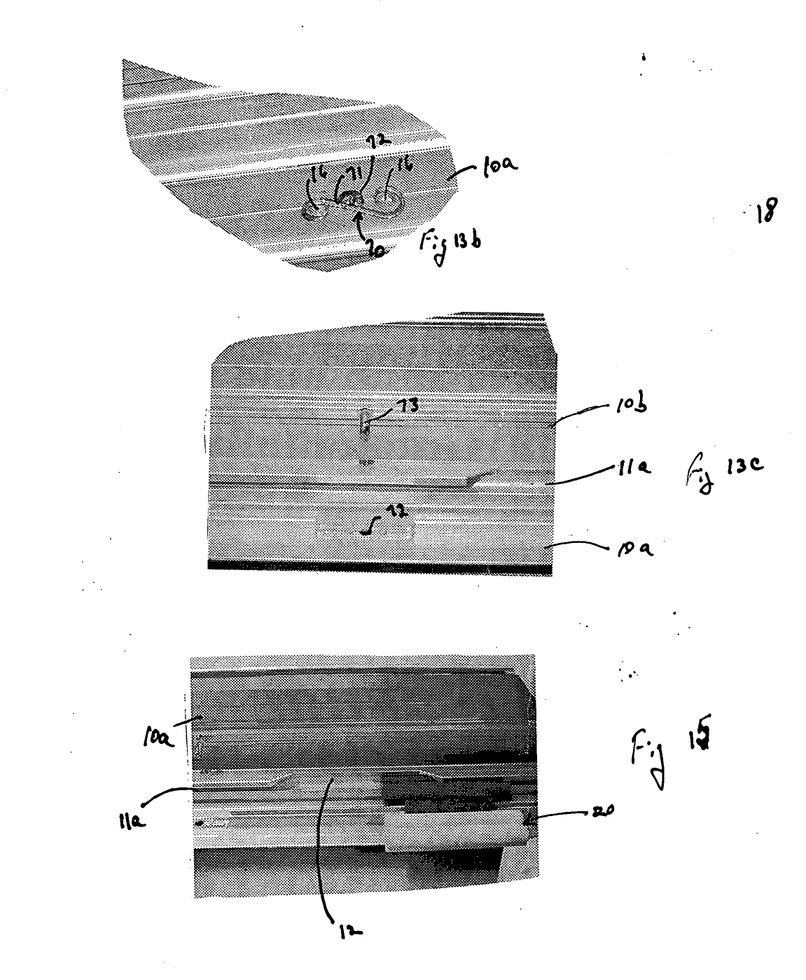

Alternatively, as shown in the embodiment of FIGS. 9, 10, 11a and 11b, bungee cord 400 is used in place of the elastic band element 40. One tube 310a of the first non-elastic connector element 300 is provided with a partial slot 310a′ and a wedge engaging shape. Similarly, the tube 510a of the second non-elastic connector element 500 is also provided with a wedge engaging shape. The bungee cord 400 is threaded through the two adjacent tubes 310a and 510a and wedged into the respective slots 310a′ and 510a′ to effect the elastic connection (as shown in FIG. 11b).

With a display used on a moving vehicle, the frame cover 10a must be held in place by non-loosening means. In one embodiment such means comprises spring clips 60 (FIG. 12) held in channel 11b of the frame base 10a (FIG. 2b). Lateral element 10b′ of the cover lob snaps into the clip between the resilient arms 60a to effect a positive holding.

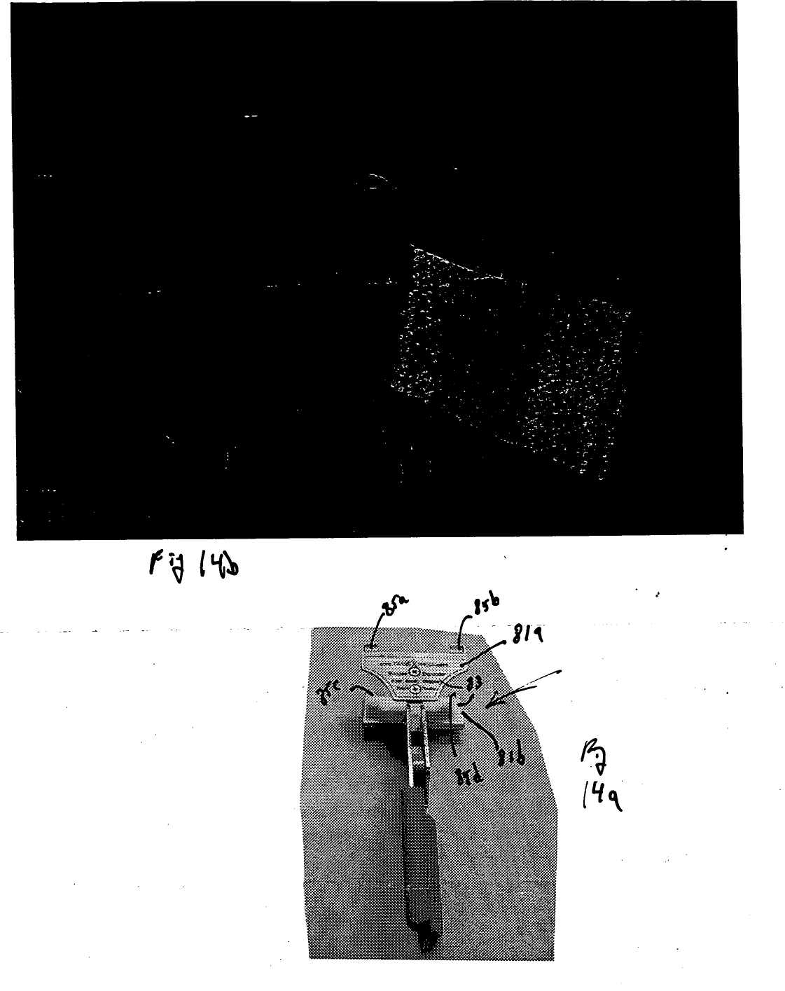

In a preferred embodiment, S-shaped tensioning spring members 70 shown in FIGS. 13a, 13b, and 13c are affixed at appropriate intervals (usually about a foot to a foot and half apart) to the rear of the base frame member 10a (shown as riveted by rivets 16 through the ends of the S in FIG. 13b. As shown in FIG. 13c, cross piece 71 of the spring is positioned across aperture 72. Quarter turn (or bayonet type) fasteners 73 with wings 75 are placed through the exterior of frame cover 10b and aligned with apertures 72. When the covers are closed, the fasteners extend through the apertures and a quarter turn causes a notch 73b to engage the cross member 71 with the turn. Release and opening of the cover simply requires a reverse quarter turn. To prevent removal of the indicia, one quarter turn fastener is positioned to span a raceway section 12 (insertion point for engagement of the indicia with the frame) of the frame 10.

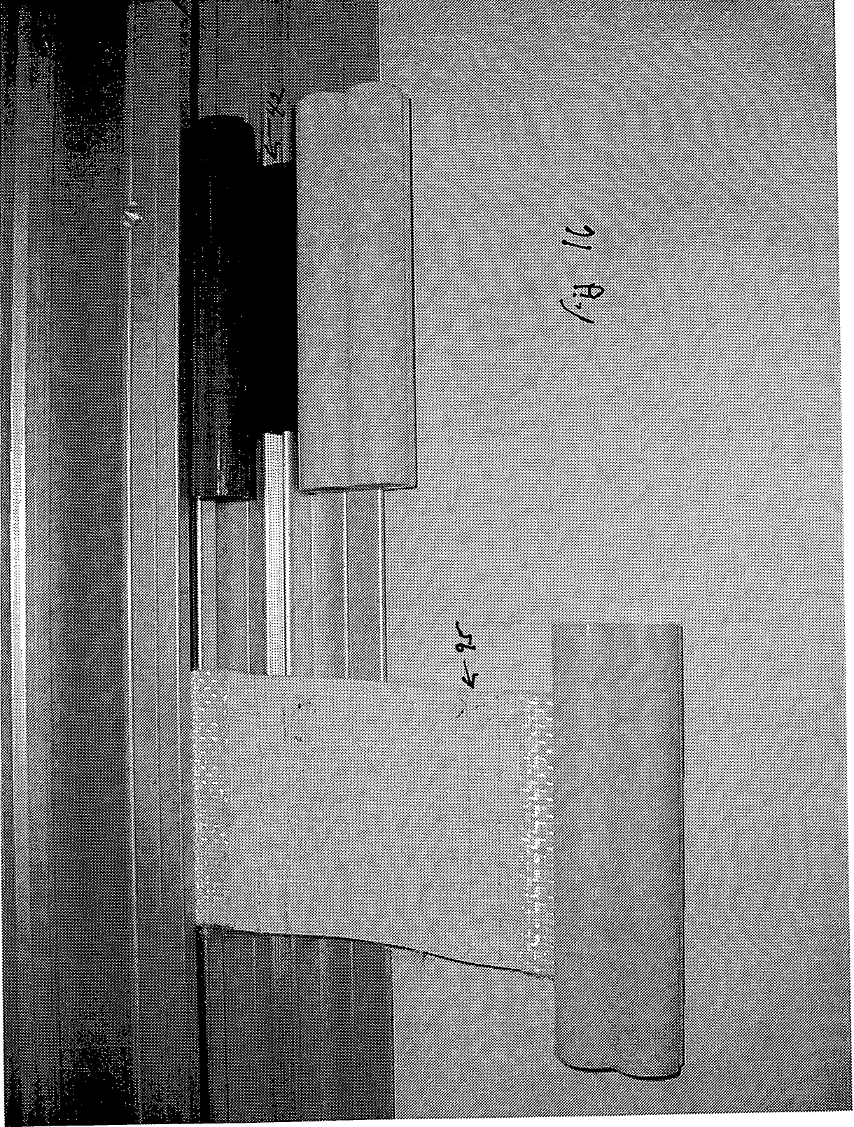

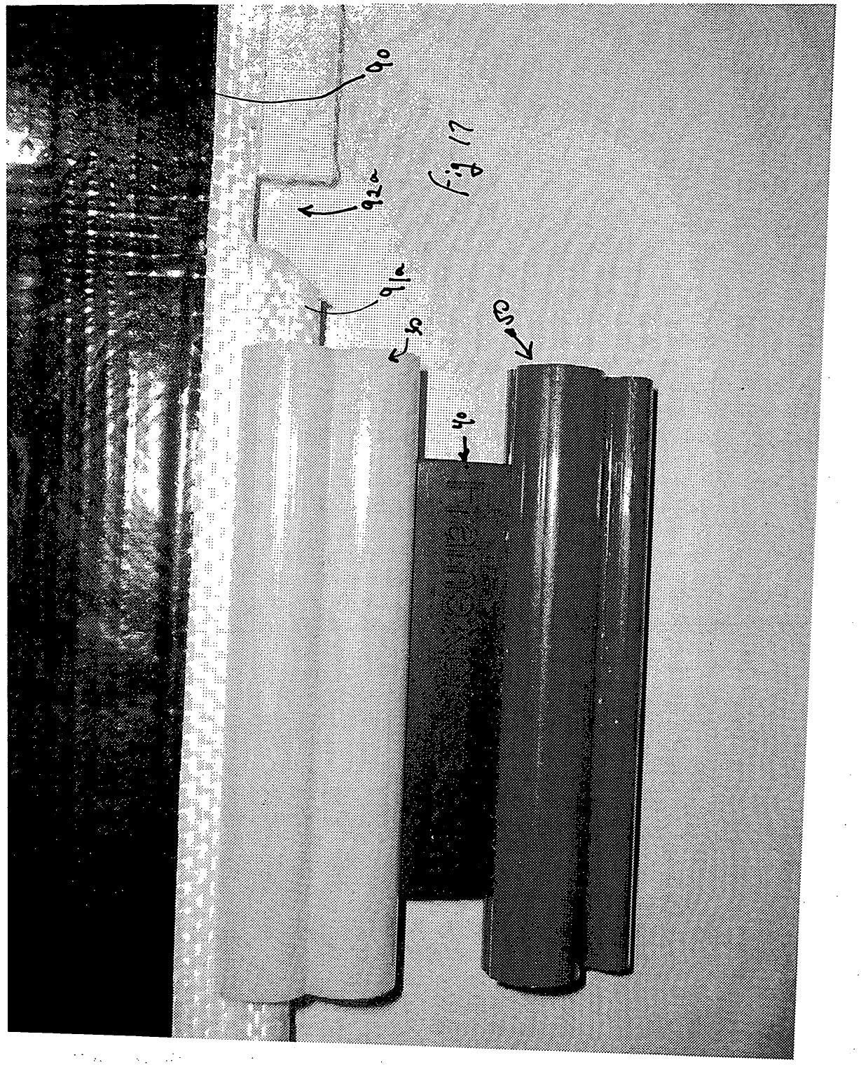

In order to properly place the connector members it is necessary to place it in tension with some extension of the elastic bungee element 40. This is however not normally readily possible because of the stiffness of the rubber. Accordingly, stretching means as embodied in the stretching tool 80, shown in FIGS. 14a and 14b is utilized. The tool comprises scissoring action elements 81a and 81b which are connected by a ratchet (not shown) which is releasable when needed. The elements 81a and 81b each comprises heavy duty slabs 83 terminating in outwardly facing cupped teeth sections 85a-d, which are adapted to conform to the outer shape of the tubes (31a, 31b and 51a of the first and second connector elements 30 and 50 respectively). The cupped teeth sections engage the sections of the tubes 31a, 31b and 51a of connector elements 30 and 50 which extend beyond the band section 42 of elastic element 40. The band is stretched by ratcheting movement of the elements 81a and 81b. The rod section 52b of the second connector element 50 is then free to be readily inserted into the raceway section 12 as shown in FIG. 15 and moved into position, at which time the ratchet is released and the connector member 20 is properly emplaced. The stretching tool is adaptable for use in other applications such as stretching springs and the like for facilitated placement.

As a safety measure, one or more safety elements 95, as shown in FIG. 16, are positioned between or adjacent the connector members. Safety elements 95 comprise bead members (not shown) bonded to a vinyl canvas material similar of that of the indicia and of a length slightly more than that of the elastic band 42. Thus, if one or more of the elastic bands 42 would snap, safety elements 95 provide a non-tensioned hold of the indicia and prevent it from falling or flying off the vehicle.

Frame member 100 shown in FIG. 4 is an alternative configuration of the frame without a cover member with a similar track section 110a. It is more suitable for use in stationary applications. Both embodiments of the frame elements are provided with slotted sections 18 and 118 for insertion of decorative moldings.

It is understood that the above description and the drawings are illustrative of the present invention and that changes in configuration, structure and components is possible without departing from the scope of the present invention as defined in the following claims.

What is claimed is:

1. A display system for display of an indicia sheet, on any one of a stationary base and on a moving vehicle base, said system comprising:
a frame element which is affixed to the stationary base or moving vehicle base; and
elastic connection means adapted to be removably positioned between and fastened to the frame element and said indicia sheet, to provide a constant tensioned connection of said indicia sheet and said frame element

2. The display system of claim 1, wherein the frame element is comprised of a plurality of straight and mitered sections abutted to one another adapted to form a continuous enclosure frame and wherein the lengths of the straight and mitered sections are adapted to provide a frame of pre-selected dimensions.

3. The display system of claim 1, wherein at least two distal edges of the indicia comprises integrated bead sections adapted for holding engagement with co-fitting elements of said elastic connection means.

4. The display system of claim 2 wherein the elastic connection means comprises first and second non-elastic elements attached to opposite ends of an elastic member, with the first non-elastic element being adapted for connection to the indicia sheet and the second non-elastic element being adapted for engagement with the frame whereby the elastic member is placed into and maintained in tension with said indicia sheet being kept thereby in a taut state.

5. The display system of claim 4, wherein said elastic member is comprised of a high strength rubber in the shape of a cord adapted to be wedged into each of said first and second non-elastic elements.

6. The display system of claim 4, wherein said elastic member is comprised of a high strength rubber in the shape of a band having ends adapted to co-fit into holding elements of said respective first and second non-elastic elements.

7. The display system of claim 4 wherein said second non-elastic element comprises an integral rod member adapted to be slidingly fitted into an enclosed track slot of said frame, wherein said enclosed track slot comprises a raceway opening for insertion of said rod member therein.

8. The display system of claim 7, wherein said frame comprises a base element, affixed to the moving vehicle base, and a cover element hingedly connected to the base element, wherein the cover element is adapted to cover the first and second non-elastic elements and the elastic member therebetween, wherein said base element and said cover element comprise tensioned means to removably fixedly maintain said cover element in a covering position.

9. The display system of claim 8 wherein the tensioned means comprises a clip element attached to one of said base and cover element and with the other of said base and cover element comprising a co-fitting engagement member positioned and adapted to be securely held by said clip element.

10. The display system of claim 8, wherein the tensioned means comprises a spring element positioned between the base element and the moving vehicle base, wherein the spring element comprises two spring members connected by a rod connection, wherein the rod connection is position adjacent an aperture in said base element and wherein a fastening element with an axial slot is placed through said cover element in registration with said aperture and rod connection, whereby turning of said fastening element causes said rod element to engage the axial slot to provide said tensioned means and whereby reverse turning effects a disengagement.

11. The display means of claim 8, wherein the hinge connection adjacent the mitred sections comprise interfitting full-nose configurations whereby hinged movement of the cover element to a closed position is not impeded.

12. The display system of claim 4, wherein safety backup elements are positioned between the indicia display and the frame with said safety backup elements comprising non-elastic material longer than said elastic member and affixed to the frame and indicia by connection means.

13. The display system of claim 12, wherein said connection means comprises said first non-elastic element for connection between said non-elastic material and the indicia display.

14. A spreading tool adapted for use in spreading the elastic member of claim 6 whereby connection of the elastic connection means to either of said indicia sheet or said frame is facilitated without impeding tension, said spreading tool comprising reinforced engagement elements held in a scissored ratcheting connection with said engagement elements adapted to engage opposite sides of the elastic member whereby the ratcheted connection effects an assisted spreading of the elastic member whereby the connection of the elastic connection means is without impeding tension and whereby the ratchet is releasable to engage the tension thereafter and permit removal of the tool.
